(19) United States
(12) Patent Application Publication
(10) Pub. No.: US 2013/0232538 A1
(43) Pub. Date: Sep. 5, 2013

(54) BLUETOOTH SHARING FOR MULTIPLE PROCESSORS

(71) Applicant: Ronald Douglas Johnson, Westfield, IN (US)

(72) Inventor: Ronald Douglas Johnson, Westfield, IN (US)

(73) Assignee: Thomson Licensing, Issy de Moulineaux (FR)

(21) Appl. No.: 13/884,318

(22) PCT Filed: Oct. 25, 2011
(86) PCT No.: PCT/US11/57745

§ 371 Date: May 9, 2013

Related U.S. Application Data
(60) Provisional application No. 61/414,973, filed on Nov. 18, 2010.

(51) Int. Cl. H04N 21/41

(52) U.S. Cl. CPC H04N 21/41
USPC 725/151

(57) ABSTRACT

A Bluetooth circuit is connected via a switch to at least two processors. The switch provides connectivity based on the power state of at least one of the processors. Bluetooth pairing keys are shared between the processors, and, therefore, re-pairing is unnecessary for each switch action.

This application claims priority from U.S. Provisional Application No. 61/414,973 filed 18 Nov. 2010.

### BACKGROUND

In a set top box (STB), a Bluetooth connection can be used, for example, for Bluetooth Advanced Audio Distribution Profile (A2DP) and Remote Control Profile (RCP). Normally, the entire Bluetooth stack is run in the microprocessor. This is a very power hungry and expensive microprocessor to support these modes.

### SUMMARY

A switch is used to share a Bluetooth integrated circuit (IC) between two processors. One processor runs reduced functionality while the system is in standby, and the other processor runs with full functionality when the system is powered on. By sharing a universal serial bus (USB) connected Bluetooth IC, system cost is reduced and the system consumes less power.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 illustrates a representative block diagram of a receiver set top box.

FIG. 2 is an example of a switchable Bluetooth solution.

FIG. 3 is a flow diagram of a method of switching Bluetooth connectivity

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

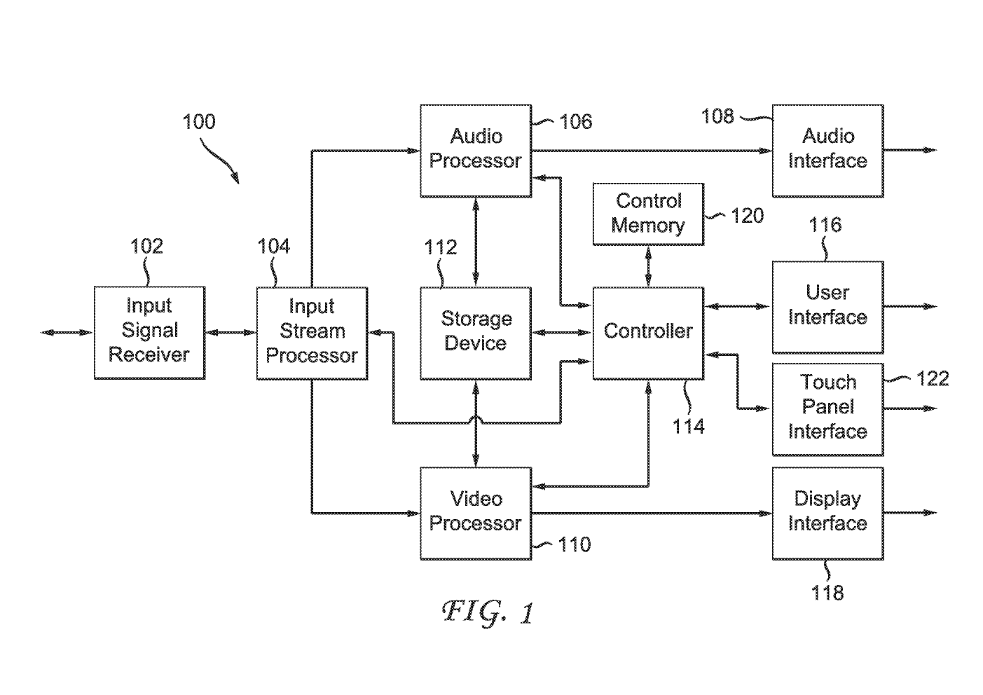

Two Bluetooth ICs can be used on a device such as, for example, a set top box, but then you have to “pair” or join with both devices. A single Bluetooth IC can be permanently connected to a microcontroller, but now audio needs to pass through that microcontroller. A single Bluetooth IC can be connected to the microprocessor but then the Bluetooth IC will be powered down when the box goes into standby and a Bluetooth connected remote control cannot be used to turn the system back on. The following, described in FIG. 1, illustrates a representative block diagram of a receiver set top box. It is important to note that the disclosed techniques can also be used in any number of products besides set top boxes, including televisions, computers, and the like, where the Bluetooth operation includes remote control functions and the device has a low power or standby mode.

Turning now to FIG. 1, a block diagram of an embodiment of a receiving device 100 is shown. Receiving device 100 can be included as part of a gateway device, modem, set top box, and/or other devices. The device 100 shown can also be incorporated into other systems including an audio device or a display device. In either case, several components necessary for complete operation of the system are not shown in the interest of conciseness, as they are well known to those skilled in the art.

In the device 100 shown in FIG. 1, the content is received by an input signal receiver 102. The input signal receiver 102 can be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 102 based on user input provided through a control interface or touch panel interface 122. Touch panel interface 122 can include an interface for a touch screen device. Touch panel interface 122 may also be adapted to interface to a cellular phone, a tablet, a mouse, a high end remote or the like.

The decoded output signal is provided to an input stream processor 104. The input stream processor 104 performs the final signal selection and processing, and includes separation of video content from audio content for the content stream. The audio content is provided to an audio processor 106 for conversion from the received format, such as compressed digital signal, to an analog waveform signal. The analog waveform signal is provided to an audio interface 108 and further to the display device or audio amplifier. Alternatively, the audio interface 108 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 104 is provided to a video processor 110. The video signal may be one of several formats. The video processor 110 provides, as necessary a conversion of the video content, based on the input signal format. The video processor 110 also performs any necessary conversion for the storage of the video signals.

A storage device 112 stores audio and video content received at the input. The storage device 112 allows later retrieval and playback of the content under the control of a controller 114 and also based on commands, e.g., navigation instructions such as fast-forward (FF) and rewind (Rew), received from a user interface 116 and/or touch panel interface 122. The storage device 112 may be a hard disk drive, one or more large capacity integrated electronic memories, such as static RAM (SRAM), or dynamic RAM (DRAM), or can be an interchangeable optical disk storage system such as a compact disk (CD) drive or digital video disk (DVD) drive.

The converted video signal, from the video processor 110, either originating from the input or from the storage device 112, is provided to the display interface 118. The display interface 118 further provides the display signal to a display device of the type described above. The display interface 118 can be an analog signal interface such as red-green-blue (RGB) or can be a digital interface such as HDMI. It is to be appreciated that the display interface 118 will generate the various screens for presenting the search results in a three dimensional grid.

The controller 114 is interconnected via a bus to several of the components of the device 100, including the input stream processor 102, audio processor 106, video processor 110, storage device 112, and a user interface 116. The controller 114 manages the conversion process for converting the input stream signal into a signal for storage on the storage device or for display. The controller 114 also manages the retrieval and playback of stored content. Furthermore, the controller 114 performs searching of content and the creation and adjusting of the display representing the content, either stored or to be delivered via the delivery networks, described above.

The controller 114 is further coupled to control memory 120 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 114. Control memory 120 can store instructions for controller 114. Control memory can also store a database of elements, such as graphic elements containing content. The database can be stored as a pattern of graphic elements. Alternatively, the memory can store the graphic elements in identified or grouped memory locations and use an access or location table to identify the memory locations for the various portions of information related to the graphic elements. Further, the implementation of the control memory 120 can include several possible embodiments, such as a single memory device or, alternatively, more than one memory circuit communicatively connected or coupled together to form a shared or common memory. Still further, the memory can be included with other circuitry, such as portions of bus communications circuitry, in a larger circuit.

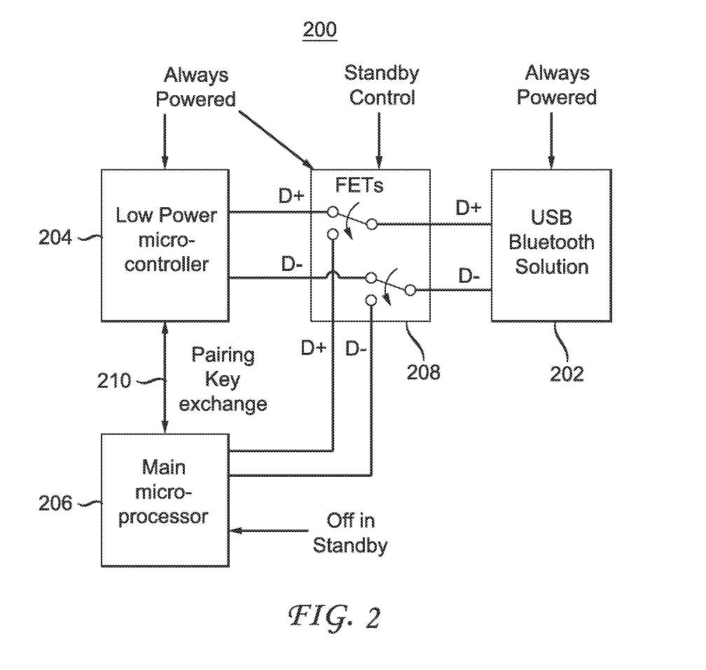

The techniques disclosed herein can be utilized with the above representative set top box as well as other devices. Thus, reference can be made, when necessary to the above layout of the example set top box. In more modern versions of a STB, a USB connection is provided by the STB for various purposes. A Bluetooth solution such as an integrated circuit can then be used to enable wireless connections with the STB. This allows, for example, control of some features of the STB via a Bluetooth compatible device such as a remote control and/or a mobile device (e.g., cell phone, portable laptop, pad, etc.) and the like. FIG. 2 is an example layout 200 of a switchable USB connected Bluetooth solution 202. The USB connected Bluetooth IC 202 can be connected to a switch 208 such as a field effect transistor (FET) switch and/or other type of electronically controlled switching device. The switch 208 can then connect the USB lines to either a small microcontroller 204 or a large STB main microprocessor 206. The main microprocessor 206 when ON has control of the USB connected Bluetooth IC 202. It 206 can run a full Bluetooth stack supporting A2DP and RCP. When the set top box goes into a standby mode, the Bluetooth IC 202 is switched over to the low power microcontroller 204 via the switch 208. The microcontroller 204 runs a small subset of the Bluetooth RCP and recognizes a wireless signal to turn the system back on via the RCP. Upon receiving this command, the main microprocessor 206 comes out of standby reassumes control of the Bluetooth IC 202. Thus, the power state can be determined by received Bluetooth wireless signals, by received user commands via a STB interface (buttons, etc. on the box) and/or by logical commands given by the circuits within the STB, etc.

Additionally, connected Bluetooth devices do not need to be paired with both the microcontroller 204 and microprocessor 206 because pairing keys can be shared between the two devices 210. The pairing information can be communicated by electrical signal paths between the processors and/or processor programming etc. Bluetooth devices only need to be paired once. The microcontroller 204 needs a lot less memory and can be a slower performance part resulting in lower system cost and/or lower standby power consumption.

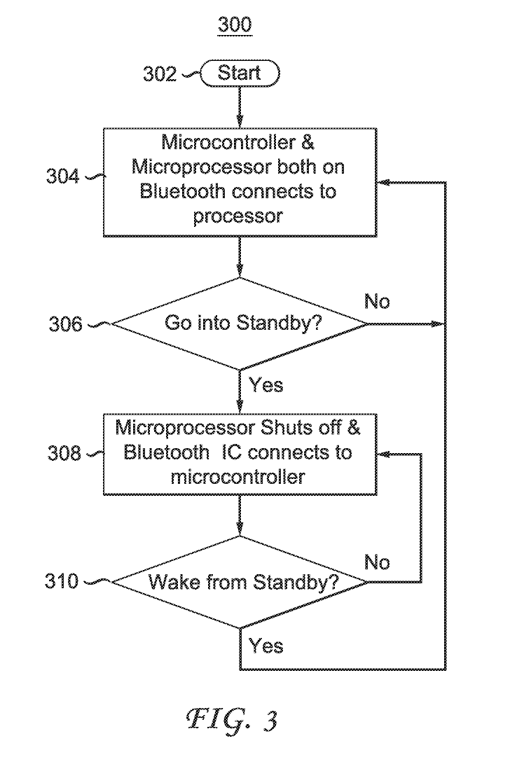

In view of the exemplary systems shown and described above, methodologies that can be implemented in accordance with the embodiments will be better appreciated with reference to the flow chart of FIG. 3. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 3 is a flow diagram of a method 300 of switching Bluetooth connectivity. The method starts 302 with both the microcontroller and microprocessor powered. A Bluetooth device connects to the microprocessor under these conditions 304. A determination is then made as to whether a standby command has been generated by a system component 306. If not, the Bluetooth device remains switched to the microprocessor. If a standby command has been received, the microprocessor powers down into a low-power standby state, and the Bluetooth device is switched to the microcontroller 308. A determination is then made as to whether a wake from standby command has been received 310. If not, the microprocessor remains in standby mode and the microcontroller remains connected to the Bluetooth device. If a wake from standby command has been received, the microcontroller is powered on and the Bluetooth device is then switched from the microcontroller to the microprocessor and the flow continues through the cycle.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that provides Bluetooth connectivity, comprising:
a first processor that provides reduced functionality for an electronic device and is capable of communicating with a Bluetooth device;
a second processor that provides normal functionality for an electronic device and is capable of communicating with a Bluetooth device; and
a switch that switches between the first and second processors based on a power state of at least one of the processors, the switch provides connectivity of the first and second processors to a Bluetooth device.

2. The system of claim 1, wherein the first and second processors share Bluetooth pairing information for the Bluetooth device.

3. The system of claim 1, wherein the switch is a field effect transistor based switch.

4. The system of claim 1, wherein the switch provides Bluetooth connectivity based on a standby power state of a processor.

5. The system of claim 1, wherein the first processor is a low-power processor.

6. The system of claim 1, wherein the second processor has a standby power state.

7. The system of claim 1 residing in a set top box.

8. A method for providing Bluetooth connectivity, comprising the steps of:
determining at least one power state of at least one processor that can connect to a Bluetooth device; and
switching Bluetooth connectivity of at least one processor based on the determined power state of the at least one processor.

9. The method of claim 8, wherein the power state can be one of a low-power state, a standby power state, a power off state, and a power on state.

10. The method of claim 8 further comprising the step of:
sharing Bluetooth pairing information between at least two processors having Bluetooth connectivity capability.

11. The method of claim 8 further comprising the step of:
switching Bluetooth connectivity to a processor with Bluetooth Advanced Audio Distribution Profile and Remote Control Profile capabilities when its power state is on.

12. The method of claim 8 further comprising the step of:
switching Bluetooth connectivity to a processor with Remote Control Profile capabilities when another processor has a power state of standby.

13. The method of claim 8 employed in a set top box.

14. A system that provides Bluetooth connectivity, comprising:
a means for determining at least one power state of at least one processor that can connect to a Bluetooth device; and
a means for switching Bluetooth connectivity of at least one processor based on the determined power state of the at least one processor.

15. The system of claim 14 further comprising:
a means for sharing Bluetooth key information between at least two processors with Bluetooth connectivity capabilities.
